(19) United States
(12) Patent Application Publication
(10) Pub. No.: US 2015/0113242 A1
(43) Pub. Date: Apr. 23, 2015

(54) RESTRICTING ACCESS TO SENSITIVE DATA IN SYSTEM MEMORY DUMPS

(71) Applicant: International Business Machines Corporation, Armonk, NY (US)

(72) Inventors: Robert M. Abrams, Wappinger Falls, NY (US); Anthony S. Grech, Beacon, NY (US)

(21) Appl. No.: 14/501,179

(22) Filed: Sep. 30, 2014

Related U.S. Application Data
(63) Continuation of application No. 14/056,080, filed on Oct. 17, 2013.

(51) Int. Cl. G06F 12/14; G06F 12/02

(52) U.S. Cl. CPC G06F 12/1416; G06F 12/0253; G06F 2212/1052; G06F 2212/702
USPC 711/163

(57) ABSTRACT

Embodiments relate to restricting access to sensitive data in system memory dumps. An aspect includes defining a memory object containing sensitive data as a secure memory object. The secure memory object is then designated to be included or excluded in system memory dumps. The secure memory object is omitted from system memory dumps if the secure memory object is designated to be excluded. On the other hand, the secure memory object is included in system memory dumps if the secure memory object is designated to be included. Although the secure memory object may be included in the system memory dump, access to the secure memory object is prevented unless a cipher is provided.

### DOMESTIC PRIORITY

This application is a continuation of U.S. patent application Ser. No. 14/056,080, filed Oct. 17, 2013, the disclosure of which is incorporated by reference herein in its entirety.

### BACKGROUND

The present invention relates generally to system memory dumps and, more specifically, to restricting access to sensitive data in system memory dumps.

In computing, a system memory dump (e.g., storage dump, core dump) is a recorded state (i.e., static snapshot) of the working memory of a computer program at a specific point in time. The system memory dump generally includes programs and data loaded and previously executed on the system at the time of the dump. The system memory dump is often used to assist in diagnosing and debugging errors in computer programs without monopolizing the computing facility. Conventionally, a diagnostic system memory dump may include loosely-formatted, sensitive personal data. For example, the dumped binary data may include tables with social security numbers and credit card numbers, which would be available to diagnostic personnel to access, format, and display the sensitive data.

### BRIEF SUMMARY

In one embodiment of this disclosure, a computer-implemented method for restricting access to sensitive data in system memory dumps includes defining, by a processing device, a memory object containing sensitive data as a secure memory object. The method further includes designating whether the secure memory object should be included or excluded in a system memory dump. The secure memory object is omitted from the system memory dump based on a designation that the secure memory object should be excluded. On the other hand, the secure memory object is included in the system memory dump based on a designation that the secure memory object should be included.

In another embodiment, a computer system for restricting access to sensitive data in system memory dumps includes a memory having computer readable computer instructions and a processor for executing the computer readable instructions to perform a method. That method includes defining, by a processing device, a memory object containing sensitive data as a secure memory object. The method further includes designating whether the secure memory object should be included or excluded in a system memory dump. The secure memory object is omitted from the system memory dump based on a designation that the secure memory object should be excluded. On the other hand, the secure memory object is included in the system memory dump based on a designation that the secure memory object should be included.

In yet another embodiment, a computer program product includes a computer readable storage medium having computer readable program code embodied thereon. The computer readable program code is executable by a processor to perform a method. The method includes defining, by a processing device, a memory object containing sensitive data as a secure memory object. The method further includes designating whether the secure memory object should be included or excluded in a system memory dump. The secure memory object is omitted from the system memory dump based on a designation that the secure memory object should be excluded. On the other hand, the secure memory object is included in the system memory dump based on a designation that the secure memory object should be included.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an embodiment;

FIG. 2 depicts a system for restricting access to sensitive data in a system memory dump according to an embodiment;

FIG. 3 depicts a system for allowing references to sensitive data in messages and trace buffers according to an embodiment; and

FIG. 4 depicts a process for restricting access to sensitive data in system memory dumps according to an embodiment.

### DETAILED DESCRIPTION

Embodiments disclosed herein are directed to restricting access to sensitive data in system memory dumps. Particularly, the disclosed embodiments may omit the sensitive data from being captured to a system memory dump. Embodiments may also limit the access by diagnostic personnel to sensitive data that is included in a system memory dump.

An aspect of embodiments includes defining a memory object containing sensitive data as a secure memory object. The secure memory object is then designated to be included or excluded in system memory dumps. The secure memory object is omitted from system memory dumps if the secure memory object is designated to be excluded. On the other hand, the secure memory object is included in system memory dumps if the secure memory object is designated to be included. Although the secure memory object may be included in the system memory dump, access to the secure memory object, such as by a dump formatting program, is prevented unless a cipher is provided.

The following terminology is used throughout this disclosure:

Sensitive Data: data of a personal nature, often used in business transactions. Examples include credit card numbers, social security numbers, and the like.

System Application: software program that saves, references, and obtains storage for sensitive data.

Data Owner: company or person owning the actual data being managed by the system application.

Diagnostic Personnel: individuals skilled in diagnosing problems based on data and codes viewed from a system memory dump.

System Memory Dump: file containing a static snapshot of memory containing programs and data loaded, and previously executed, on the system at the time of the dump.

Secure Memory Objects: segments of system memory that can only be accessed using a cipher provided by the data owner. Any references to data in memory objects without the specific cipher are rejected.

Cipher: key defined by the data owner, which may be transmitted to diagnostic personnel to allow the data to be read in a system memory dump. According to an embodiment, the cipher is not sent with the data, but may be sent securely to requesting diagnostic personnel if allowed by the data owner.

An aspect of embodiments defines secure memory objects in system-managed memory that may be included in standard operating system dumps, but are not accessible to dump analysis and formatting tools without a cipher code provided by the data owner. That is, embodiments allow sensitive data to be “invisible” to system diagnostic personnel depending on the installation security and the First Failure Data Capture (FFDC) requirements. By allowing the data to be included in the system memory dump, the data can be accessed by trusted personnel in the installation or service provider without requiring a recreate to obtain the data according to embodiments. Memory access provided by the operating system prevents accidental access by casual diagnostic personnel by preventing access to secure areas of storage without the data-owner's cipher according to embodiments.

Another aspect of embodiments prevents secure memory objects from being included in the system memory dump, as defined by the installation. That is, embodiments may create system memory dumps that do not including the memory objects containing sensitive data, even though that data is present on the system.

Another aspect of embodiments prevents the inclusion of sensitive data in messages and trace buffers. According to embodiments, a method is provided that allows the application software to reference sensitive data in messages and trace buffers without including the actual data.

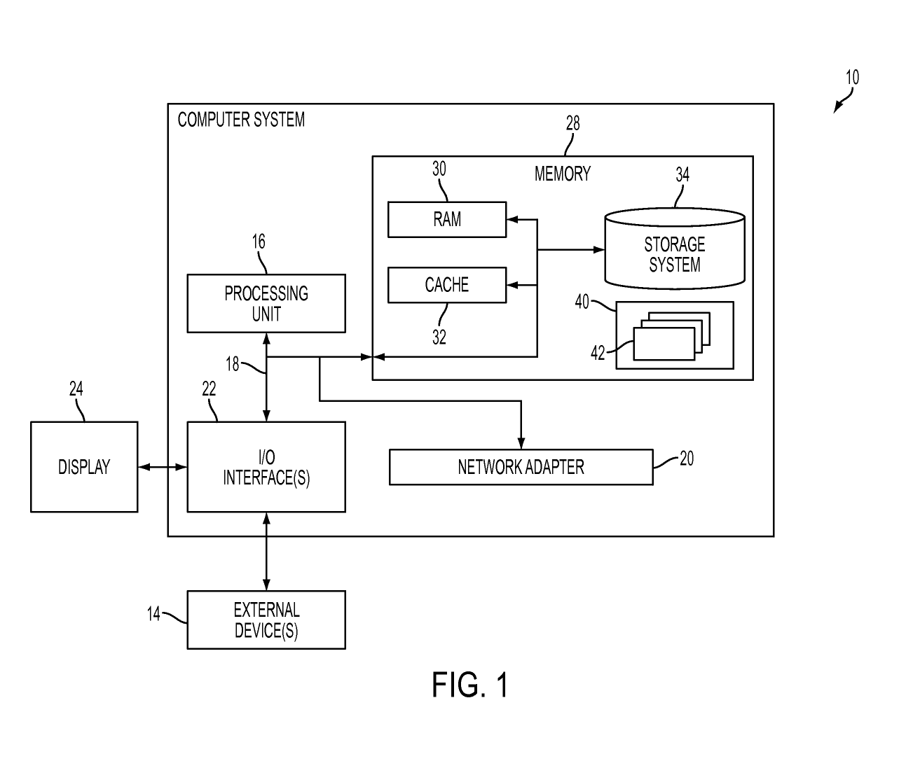

Referring now to FIG. 1, a block diagram of a computer system 10 suitable for restricting access to sensitive data in system memory dumps according to exemplary embodiments is shown. Computer system 10 is only one example of a computer system and is not intended to suggest any limitation as to the scope of use or functionality of embodiments described herein. Regardless, computer system 10 is capable of being implemented and/or performing any of the functionality set forth hereinabove.

Computer system 10 is operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a general-purpose computing device, also referred to as a processing device. The components of computer system may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

An embodiment disclosed herein may be leveraged by programming languages (e.g., C, C++, Java) and used by application programs when obtaining storage for sensitive data to obtain secure memory objects associated exclusively with the application. A system parameter may indicate whether the secure memory objects should be marked “do not include in dump” so the system memory dump does not accidentally contain the memory buffers.

An embodiment may identify a memory object as containing sensitive data, which should be isolated from access by other programs in the system. Any attempts to access the data programmatically are only allowed by the application that obtained the data according to an embodiment. Any attempts to access the data by unauthorized formatting tools are rejected according to an embodiment.

According to another embodiment, operator (i.e., administrator) dump commands that result in dumping memory objects only include sensitive data if allowed by the system parameter. An option to avoid dumping sensitive data areas must work for non-disruptive targeted externally requested dumps and disruptive system-wide standalone dumps according to an embodiment.

A dump analysis and formatting tool of an embodiment may allow sensitive memory objects to be formatted and displayed only when the data-owner's cipher is provided. The default may prevent display of sensitive memory objects, unless the correct cipher is provided. Accordingly, diagnostic personnel must treat the cipher as company confidential data and not share it with other individuals inside or outside their company to prevent accidental or malicious exposure of personal sensitive data. The data owner should avoid sharing the cipher unless absolutely necessary and all such sharing should be tracked for later auditing according to an embodiment. According to another embodiment, name/token pairs may be used for referencing sensitive data in traces and log data.

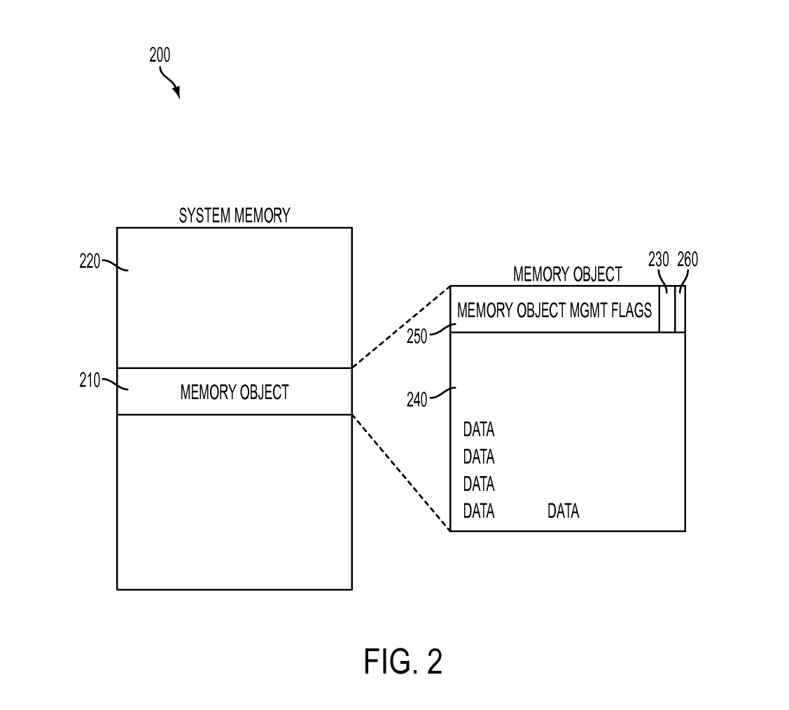

With reference to FIG. 2, a system 200 for restricting access to sensitive data in a system memory dump according to an embodiment is shown. According to an embodiment, a memory object 210 of a system memory 220 may be defined as a secure memory object with a secure memory object attribute (i.e., flag) 230. The secure memory object attribute indicates that all data contained in a data area 240 of the memory object 210 is sensitive data. According to an embodiment, the secure memory object attribute 230 is included in the header 250 of the memory object 210.

According to an embodiment, secure memory objects are included in system memory dumps to facilitate First Failure Data Capture (FFDC). However, the installation can elect to have a memory object 210 omitted from system memory dumps to comply with company security guidelines, for example. According to an embodiment, a dump attribute 260 is included in the header 250 of the memory object 210 to indicate whether the memory object 210 should be included in a system memory dump.

For example, a secure memory object may be located in 64-bit virtual storage and system memory dumps may be initiated by an operator using a dump command, or any other initiator of system memory dumps. According to an embodiment, prior to dumping each memory object 210 related to an application (i.e., address space) being dumped, the secure memory object attribute 230 is checked to determine whether the data area 240 is secure. Additionally, the dump attribute 260 is checked to determine whether the secure memory object is to be dumped.

Application programs may be written in application languages like C, C++ and Java, however some applications are written in the assembler language for the target machine architecture. Data areas defined using these languages may offer an attribute of secure on all data objects, which will cause the compiler to generate an operating system request for secure memory. Accordingly, programs written in assembler language would need to use the secure option directly when the program obtains working memory (e.g., STORAGE OBTAIN, LENGTH=nn, SUBPOOL-nn, TYPE=SECURE). Other options specified when obtaining memory include the required length of the area and request for a token to be used when accessing data in the particular memory area.

By default, any programmable access to data in secure data areas by the program that requested the data object continues to occur. However, programmable access to the memory object by other programs is restricted by the application to only programs specifying the data-object-token returned by the STORAGE OBTAIN. This provides improved security on access of sensitive data according to an embodiment.

According to an embodiment, system dump controls (e.g., dump attribute 260) enforce whether sensitive data contained in secure data areas are included in binary system memory dumps created by the operating system. By default, secure data areas are not included in the storage dumps according to an embodiment. This prevents accidental disclosure of sensitive data contained in secure memory objects by omitting them from the system memory dump. However, it also impacts FFDC. In a controlled environment, or where FFDC is of utmost importance, the default may include sensitive data objects in the system memory dump. However, according to an embodiment, access to the dumped sensitive data may be prevented.

In situations where sensitive data areas are captured in the dump, the diagnosis of errors in an application using the secure data objects will require that the sensitive data be included in the dump. A formatting tool may restrict access to the dumped secure memory objects to programs that specify an installation's cipher according to an embodiment.

To ensure that such disclosure is intentional and protected, an installation may use system operator dump controls to indicate that sensitive data should be included in system memory dumps via the secure memory object attribute 230 according to an embodiment. When indicating that the sensitive data should be included, a cipher code may be provided by the installation according to an embodiment. This cipher code may be provided to trusted diagnostic personnel for gaining access to the sensitive data when formatting and analyzing the dump.

When an operator initiates a system memory dump of the application's memory areas (i.e., program and all data related to the application program), the dumping process of an embodiment determines, for each memory object 210, whether it is a secure memory object via the secure memory object attribute 230, and whether the installation allows secure memory objects to be included in the system memory dump via the dump attribute 260. The default action may be to omit the sensitive data areas from the system memory dump. However, if the operator dump controls indicate that secure memory objects may be included in the dump, then they are included along with sufficient memory object controls to control access by dump analysis programs according to an embodiment.

Diagnostic personnel may use a tool to format and analyze the system memory dump. The tool must use the installation's cipher code to access the secure memory objects according to an embodiment. Otherwise, access to the secure memory objects is rejected by the system of an embodiment. The presence of the cipher code indicates that the viewer is trusted to access the data according to an embodiment.

According to an embodiment, standalone dump logic may perform the same types of checks prior to dumping secure memory objects. The standalone dump may check each memory object header 250 before including the memory object 210 in the system memory dump. This may slow down the dump process, but it prevents sensitive data from being included in the system memory dump.

A system-wide operator dump control of an embodiment may restrict the inclusion of sensitive data in operator-requested system memory dumps. Alternatively, if the system-wide operator dump control allows sensitive data is to be included in the system memory dumps, a cipher code (e.g., CHNGDUMP SENSITIVEDATA {NODUMP} {DUMP, CIPHER=nnnnnnnnnnnn}) may be used to capture the sensitive data. The same cipher code may be used to access the sensitive data, such as in a dump analysis and formatting tool.

According to an embodiment, an operator may initiate a system memory dump of a job. The system memory dump may include all data areas associated with the job. If an application is associated with memory objects containing sensitive memory as determined by checking the secure memory object attribute 230, then the dump attribute 260 is checked to determine whether the sensitive data should be included in the system memory dump. If the dump attribute 260 indicates that the sensitive data should not be included in the system memory dump, then the sensitive data is omitted accordingly. If the dump attribute 260 indicates that the sensitive data should be included in the system memory dump, then the sensitive data may only be accessed by diagnostic personnel with access to the customer's cipher code. A diagnostic personnel's use of a dump analysis and formatting tool generally provides access to memory in a system memory dump using a system facility. If the data area being accessed contains sensitive data, however, the data is not presented by the tool unless the user provides the installation's cipher code according to an embodiment.

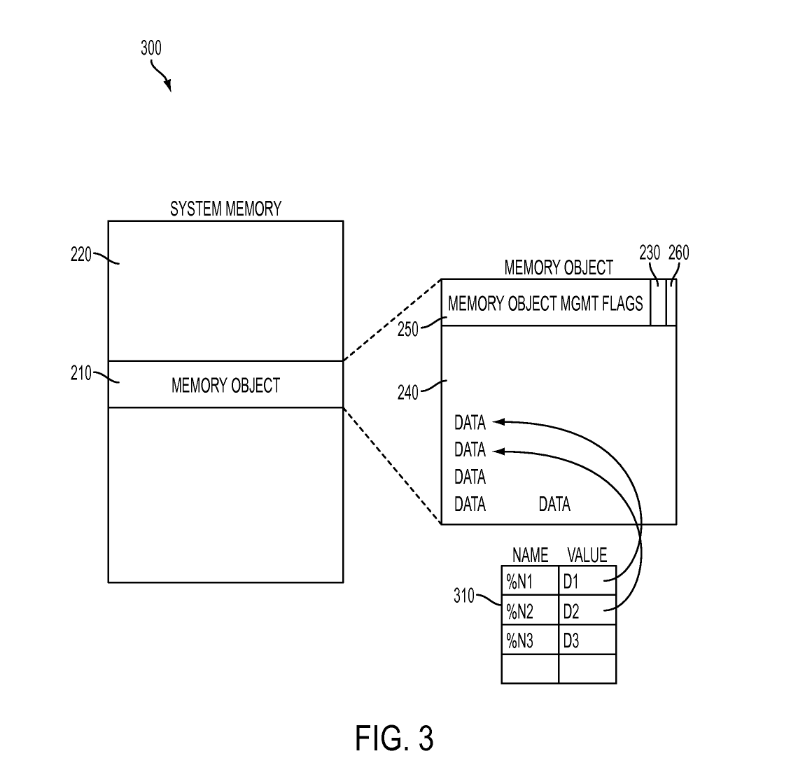

FIG. 3 depicts a system 300 for allowing references to sensitive data in messages and trace buffers according to an embodiment. According to an embodiment, a name-value table 310 is generated. This table allows each data value in the data area 240 to be referenced by a name or tag, alleviating the need to disclose the sensitive data. Accordingly, in the actual message or trace content, a program may then refer to each sensitive data object via the name or tag in the name-value table 310.

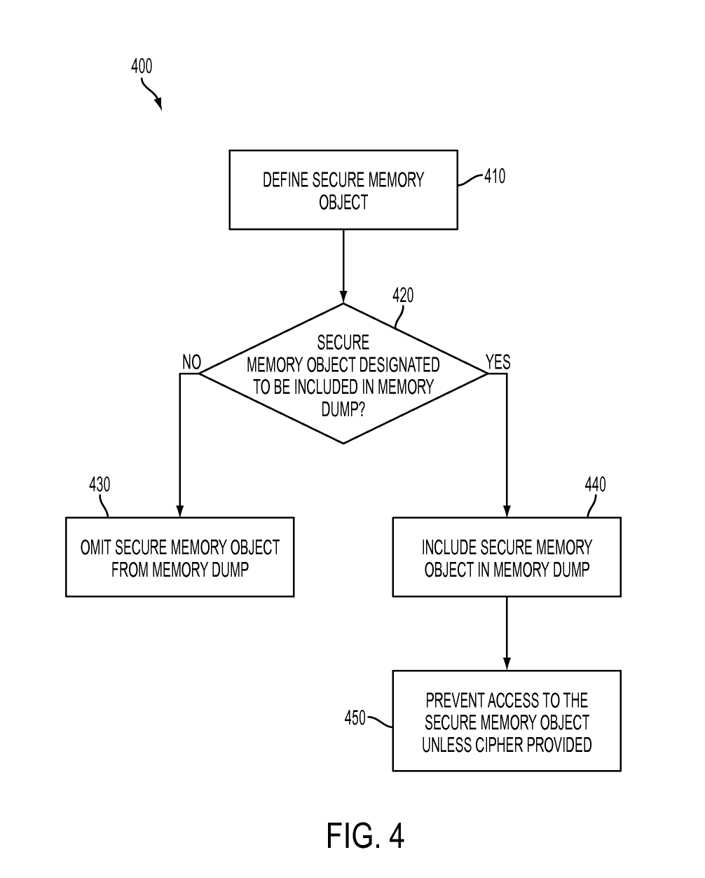

FIG. 4 depicts a process 400 for restricting access to sensitive data in system memory dumps according to an embodiment. At block 410, a memory object containing sensitive data is defined as a secure memory object. The secure memory object is then designated to be included or excluded in system memory dumps, as shown in block 420. According to an embodiment, the secure memory object is omitted from system memory dumps if the secure memory object is designated to be excluded, as shown in block 430. On the other hand, the secure memory object is included in system memory dumps if the secure memory object is designated to be included, as shown in block 440. When the secure memory object is included in system memory dumps, access to the secure memory object is initially prevented until a cipher is provided by diagnostic personnel, as shown in block 450.

Technical effects and benefits include allowing sensitive data to be “invisible” to system diagnostic personnel. By allowing the data to be included in the system memory dump, the data can be accessed by trusted personnel in the installation or service provider without requiring a recreate to obtain the data according to embodiments. Embodiments prevent accidental access by casual diagnostic personnel by preventing access to secure areas of storage without the data-owner's cipher. Embodiments may prevent secure memory objects from being included in the system memory dump, even though that data is present on the system. Embodiments may also prevent the inclusion of sensitive data in messages and trace buffers by allowing application software to reference sensitive data in messages and trace buffers without including the actual data.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for restricting access to sensitive data in system memory dumps, comprising:
defining, by a processing device, a memory object containing sensitive data as a secure memory object;
designating whether the secure memory object should be included or excluded in a system memory dump;
omitting the secure memory object from the system memory dump based on a designation that the secure memory object should be excluded; and
including the secure memory object in the system memory dump based on a designation that the secure memory object should be included.

2. The computer-implemented method of claim 1, wherein the defining of the secure memory object further comprises setting an attribute in a header of the memory object.

3. The computer-implemented method of claim 1, wherein the designating further comprises setting an attribute in the header of the secure memory object.

4. The computer-implemented method of claim 1, wherein the including of the secure memory object in the system memory dump further comprises preventing access to the secure memory object.

5. The computer-implemented method of claim 1, wherein the including of the secure memory object in the system memory dump further comprises allowing access to the secure memory object when a cipher is provided.

6. The computer-implemented method of claim 1, further comprising referencing each sensitive data object in the secure memory object with a tag in a reference table.

7. A computer program product comprising a computer readable storage medium having computer readable program code embodied thereon, the computer readable program code executable by a processor to perform a method comprising:
defining a memory object containing sensitive data as a secure memory object;
designating whether the secure memory object should be included or excluded in a system memory dump;
omitting the secure memory object from the system memory dump based on a designation that the secure memory object should be excluded; and
including the secure memory object in the system memory dump based on a designation that the secure memory object should be included.

8. The computer program product of claim 7, wherein the defining of the secure memory object further comprises setting an attribute in a header of the memory object.

9. The computer program product of claim 7, wherein the designating further comprises setting an attribute in the header of the secure memory object.

10. The computer program product of claim 7, wherein the including of the secure memory object in the system memory dump further comprises preventing access to the secure memory object.

11. The computer program product of claim 7, wherein the including of the secure memory object in the system memory dump further comprises allowing access to the secure memory object when a cipher is provided.

12. The computer program product of claim 7, the method further comprising referencing each sensitive data object in the secure memory object with a tag in a reference table.
